(19) United States
(12) Patent Application Publication
(10) Pub. No.: US 2022/0179699 A1
(43) Pub. Date: Jun. 9, 2022

(54) METHOD AND SYSTEM FOR COMPOSED INFORMATION HANDLING SYSTEM REALLOCATIONS BASED ON PRIORITY

(71) Applicant: Dell Products L.P., Hopkinton, MA (US)

(72) Inventors: Walter A. O'Brien, III, Westborough, MA (US); Mark Steven Sanders, Roanoke, VA (US); Robert Wayne Hormuth, Cedar Park, TX (US); Mukund P. Khatri, Austin, TX (US); Yossef Saad, Ganei Tikva (IL); Elie Antoun Jreij, Pflugerville, TX (US); Jimmy Doyle Pike, Georgetown, TX (US); William Price Dawkins, Lakeway, TX (US); Gaurav Chawla, Austin, TX (US); John S. Harwood, Boston, MA (US)

(21) Appl. No.: 17/117,028

(22) Filed: Dec. 9, 2020

(51) Int. Cl. G06F 9/50; G06F 9/48; G06F 11/30

(52) U.S. Cl. CPC G06F 9/505; G06F 9/5077; G06F 2209/5021; G06F 11/3051; G06F 9/4881

(57) ABSTRACT

A method includes after being allocated to a composed information handling system of the composed information handling systems: monitoring, by a system control processor manager, health of computing resources of the composed information handling system, making a determination that a computing resource of the computing resources is in a compromised state, based on the determination, identifying a second computing resource currently allocated to a second composed information handling system, wherein the composed information handling system is associated with a first priority and the second composed information handling system is associated with a second priority, wherein the first priority is higher than the second priority, and replacing, after the deallocating, the compute resource with the second compute resource in the composed information handling system.

### BACKGROUND

Computing devices may provide services. To provide the services, the computing devices may include hardware components and software components. The services provided by the computing devices may be limited by these components.

### SUMMARY

In general, in one aspect, the invention relates to a system that includes persistent storage and a system control processor manager programmed to: after being allocated to a composed information handling system of the composed information handling systems: monitor health of computing resources of the composed information handling system, make a determination, based on the monitoring of the health of the computing resources, that a computing resource of the computing resources is in a compromised state, based on the determination, identify a second computing resource currently allocated to a second composed information handling system, wherein the composed information handling system is associated with a first priority and the second composed information handling system is associated with a second priority, wherein the first priority is higher than the second priority, wherein the identifying is based at least on the first priority and the second priority, deallocate, based on the identifying, the second computing resource currently allocated to the second composed information handling system, and replace, after the deallocating, the compute resource with the second compute resource in the composed information handling system.

In general, in one aspect, the invention relates to a method for providing computer implemented services using information handling systems. The method includes after being allocated to a composed information handling system of the composed information handling systems: monitoring, by a system control processor manager, health of computing resources of the composed information handling system, making a determination, based on the monitoring of the health of the computing resources, that a computing resource of the computing resources is in a compromised state, based on the determination, identifying a second computing resource currently allocated to a second composed information handling system, wherein the composed information handling system is associated with a first priority and the second composed information handling system is associated with a second priority, wherein the first priority is higher than the second priority, wherein the identifying is based at least on the first priority and the second priority, deallocating, based on the identifying, the second computing resource currently allocated to the second composed information handling system, and replacing, after the deallocating, the compute resource with the second compute resource in the composed information handling system.

In general, in one aspect, the invention relates to a non-transitory computer readable medium that includes computer readable program code, which when executed by a computer processor enables the computer processor to perform a method for providing computer implemented services using information handling systems. The method includes after being allocated to a composed information handling system of the composed information handling systems: monitoring, by a system control processor manager, health of computing resources of the composed information handling system, making a determination, based on the monitoring of the health of the computing resources, that a computing resource of the computing resources is in a compromised state, based on the determination, identifying a second computing resource currently allocated to a second composed information handling system, wherein the composed information handling system is associated with a first priority and the second composed information handling system is associated with a second priority, wherein the first priority is higher than the second priority, wherein the identifying is based at least on the first priority and the second priority, deallocating, based on the identifying, the second computing resource currently allocated to the second composed information handling system, and replacing, after the deallocating, the compute resource with the second compute resource in the composed information handling system.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a diagram of a system in accordance with one or more embodiments of the invention.

FIG. 1.2 shows a diagram of an information handling system in accordance with one or more embodiments of the invention.

FIG. 2 shows a diagram of hardware resources in accordance with one or more embodiments of the invention.

FIG. 3 shows a diagram of a system control processor in accordance with one or more embodiments of the invention.

FIG. 4 shows a diagram of a system control processor manager in accordance with one or more embodiments of the invention.

FIG. 5.1 shows a flowchart of a method of generating a composed information handling system in accordance with one or more embodiments of the invention.

FIG. 5.2 shows a flowchart of a method of reallocating computing resources in a composed information handling system in accordance with one or more embodiments of the invention.

FIGS. 6.1-6.2 show a diagram of the operation of an example system over time in accordance with one or more embodiments of the invention.

FIG. 7 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to systems, devices, and methods for providing computer implemented services. To provide computer implemented services, computing resources may need to be allocated for the performance of the services. The services may include, for example, processing resources, memory, resources, storage resources, computing resources, etc.

To allocate the computing resources, composed information handling systems may be instantiated. A composed information handling system may be a device (the components of which may be distributed across one or more information handling systems) that has exclusive use over a quantity of computing resources. Computing resources from multiple information handling systems may be allocated to a composed information handling system thereby enabling a composed information handling system to utilize computing resources from any number of information handling systems for performance of corresponding computer implemented services.

To allocate computing resources, the system may include a system control processor manager. The system control processor manager may obtain composition requests and/or recomposition requests. These requests may indicate a desired outcome such as, for example, quantities of computing resources to be provided to a composed information handling system and/or modifications of existing allocations.

After a composed information handling system is instantiated, the health of computing resources of the composed information handling system may be monitored to ascertain whether the resources have been compromised. If the resources have been compromised, then the system may take action to recompose the computing resources so that different hardware devices are used to provide the computing resources.

The selection of the different hardware resources may be selected from secondary composed information handling systems. Specifically, the system control manager may utilize a priority associated with the secondary composed information handling systems. In one or more embodiments of the invention, a priority is a representation of the value of the composed information handling system relative to other composed information handling systems. A composed information handling system with a high priority with compromised resources may obtain the necessary resources to remediate the comprised resources using a composed information handling system of a lower priority. By doing so, the system may automatically, and without requiring user intervention, proactively address potential resource compromises that may otherwise reduce the quality of or prevent computer implemented services from being provided using the composed information handling system. Further, addressing such potential resource compromises may be performed even while all resources have been allocated.

Accordingly, phantom slowdowns or other performance hiccups that may degrade a quality of a user's experience of the computer implemented services may be automatically remediated. Additionally, by recomposing computing resources, composed information handling systems may not need to be overprovisioned with computing resources because compromises in those resources will be automatically remediated. Consequently, the efficiency of computing resource use may be improved by more efficiently allocating (e.g., increasing utilization rate) computing resources.

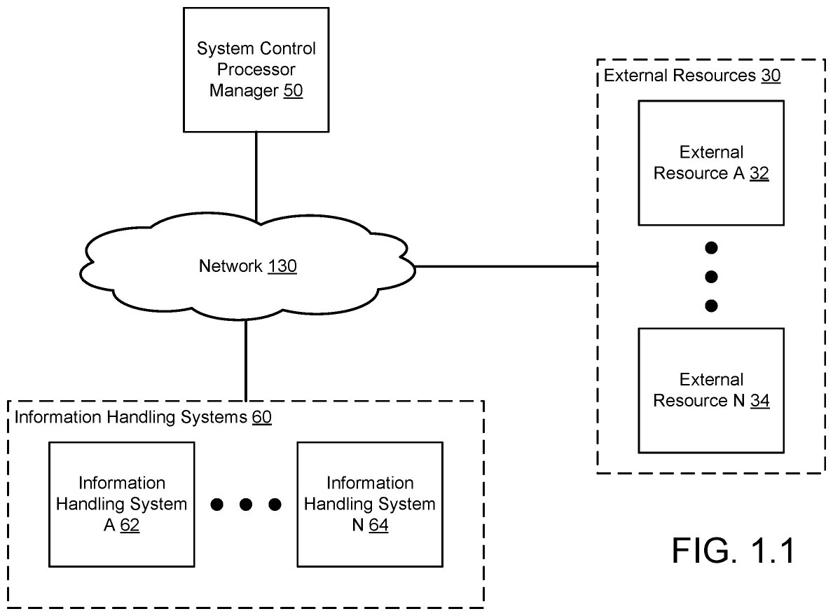

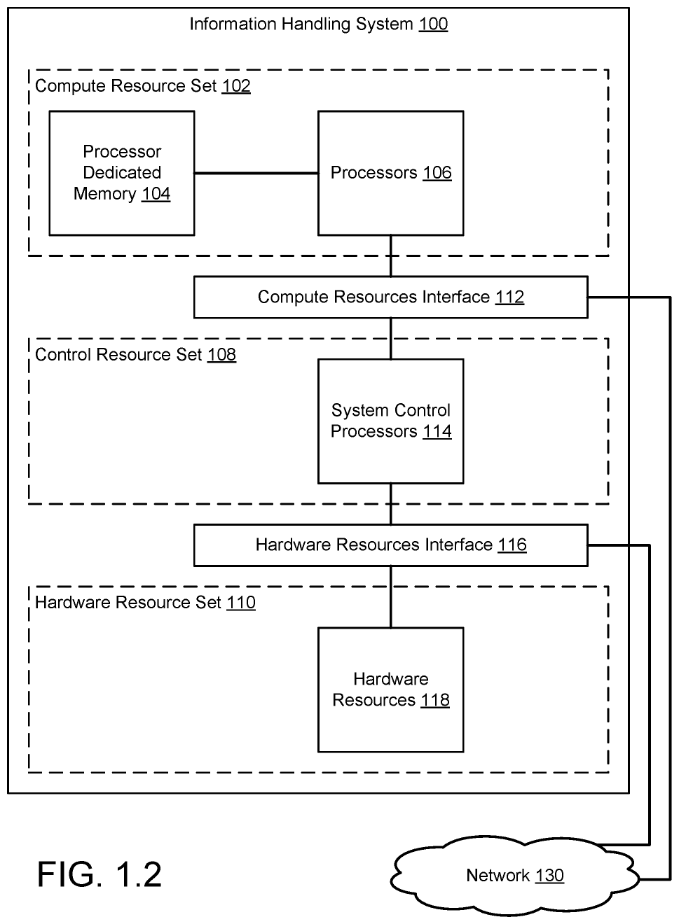

FIG. 1.1 shows a system in accordance with one or more embodiments of the invention. The system may include any number of information handling systems (60). The information handling systems (60) may provide computer implemented services. The computer implemented services may include, for example, database services, data storage services, electronic communications services, data protection services, and/or other types of services that may be implemented using information handling systems.

The information handling systems of FIG. 1.1 may operate independently and/or cooperatively to provide the computer implemented services. For example, a single information handling system (e.g., 62) may provide a computer implemented service on its own (i.e., independently) while multiple other information handling systems (e.g., 62, 64) may provide a second computer implemented service cooperatively (e.g., each of the multiple other information handling systems may provide similar and or different services that form the cooperatively provided service).

To provide computer implemented services, the information handling systems (60) may utilize computing resources provided by hardware devices. The computing resources may include, for example, processing resources, storage resources, memory resources, graphics processing resources, communications resources, and/or other types of resources provided by the hardware devices. Various hardware devices may provide these computing resources.

The type and quantity of computing resources required to provide computer implemented services may vary depending on the type and quantity of computer implemented services to be provided. For example, some types of computer implemented services may be more compute intensive (e.g., modeling) while other computer implemented services may be more storage intensive (e.g., database) thereby having different computing resource requirements for these different services. Consequently, computing resources may be used inefficiently if the quantity of computing resources is over-allocated for the computer implemented services. Similarly, the quality of the provided computer implemented services may be poor or otherwise undesirable if computing resources are under-allocated for the computer implemented services.

In general, embodiments of the invention relate to systems, methods, and devices for managing the hardware resources of the information handling systems (60) and/or other resources (e.g., external resources (30)) to provide computer implemented services. The hardware resources of the information handling systems (60) may be managed by instantiating one or more composed information handling systems using the computing resources of the information handling systems (60), external resources (30), and/or other types of hardware devices operably connected to the information handling systems (60). Consequently, the computing resources allocated to a composed information handling system may be tailored to the specific needs of the services that will be provided by the composed information handling system.

Overtime, the quality and/or quantity of computing resources provided by various hardware devices may change. For example, overtime some of the storage cells of a solid state disk may fail thereby resulting in a reduction of the quantity of storage resources that the solid state disk may provide. In another example, a hard disk drive may fail thereby rending the hard disk drive unable to provide any storage resources. Consequently, a computing resource may be compromised (e.g., enter a compromised state) when the quantity and/or quality of computing resources that may be provided using one or more hardware devices changes.

When the quantity of computing resources able to be provided by one or more hardware devices changes, it may negatively impact the quality of computer implemented services provided using the computing resources. For example, the rate of provided services may decrease, the quantity of services that can be provided may decrease, and/or a service may no longer be able to be provided.

To provide consistent qualities of computer implemented services, the system of FIG. 1.1 may provide health management services for its components. Health management services may include taking action when computing resources enter compromised states. The actions taken may include recomposing the resources so that the computing resources may transition from the compromised state to a nominal state (e.g., a state in which the hardware devices providing the computing resources are not impaired or lack capability to provide nominal quantities of computing resources).

To provide health management services, the system may include a system control processor manager (50). The system control processor manager (50) may provide composed information handling system management services. Composed information handling system management services may include (i) obtaining composition requests for composed information handling systems from, for example, the clients (not shown), (ii) aggregating computing resources from the information handling systems (60) and/or external resources (30) using system control processors to service the composition requests by instantiating composed information handling systems in accordance with the requests, and (iii) modifying resource allocations for composed information handling systems to address compromised computing resources utilized by the composed information handling systems. By doing so, instantiated composed information handling systems may provide computer implemented services in accordance with the expectations of the clients and consistently overtime by automatically addressing changes in the quantity of computing resources available to the composed information handling systems.

To determine whether to modify resource allocations, the system control processor manager (50) may monitor, for example, the states of computing resources allocated to the composed information handling systems. For example, the system control processor manager may request or may otherwise obtain reports from system control processors regarding the health (e.g., compromise states) of computing resources utilized by the composed information handling systems. The system control processor manager may utilize the obtain information to determine whether (i) computing resources should be immediately recomposed or (ii) recomposition of the computing resources should be delayed to future points in time (e.g., if a compromised state of a computing resources does not limit the ability of a composed information handling system to provide computer implemented services).

If the system control processor manager (50) determines, based on the monitoring, that computing resources of one or more composed information handling systems should be recomposed, then the system control processor manager (50) may (i) identify replacement computing resources for all or a portion of the hardware devices providing the computing resources in the compromised state, (ii) deallocate all or a portion of the aforementioned hardware devices, and (iii) allocate the replacement computing resources to the one or more composed information handling systems. By doing so, the computer implemented services provided by the composed information handling systems may be more likely to meet the expectations of the clients by virtue of the consistent quantity of computing resources available for providing the services.

To monitor the health of the computing resources of composed information handling systems, the system control processor manager (50) may instruct system control processors of the composed information handling systems to monitor the aforementioned computing resources. For example, the system control processor manager (50) may send corresponding instructions to the system control processors via any communications scheme.

Prior to monitoring the health of the computing resources of the composed information handling systems, the system control processor manager (50) may instantiate the composed information handling systems in accordance with a three-resource set model. As will be discussed in greater detail below, the computing resources of an information handling system may be divided into three logical resource sets: a compute resource set, a control resource set, and a hardware resource set. Different resource sets, or portions thereof, from the same or different information handling systems may be aggregated (e.g., caused to operate as a computing device) to instantiate a composed information handling system having at least one resource set from each set of the three-resource set model.

By logically dividing the computing resources of an information handling system into these resource sets, different quantities and types of computing resource may be allocated to each composed information handling system thereby enabling the resources allocated to the respective information handling system to match performed workloads. Further, dividing the computing resources in accordance with the three-resource set model may enable different resource sets to be differentiated (e.g., given different personalities) to provide different functionalities. Consequently, composed information handling systems may be composed on the basis of desired functionalities rather than just on the basis of aggregate resources to be included in the composed information handling system.

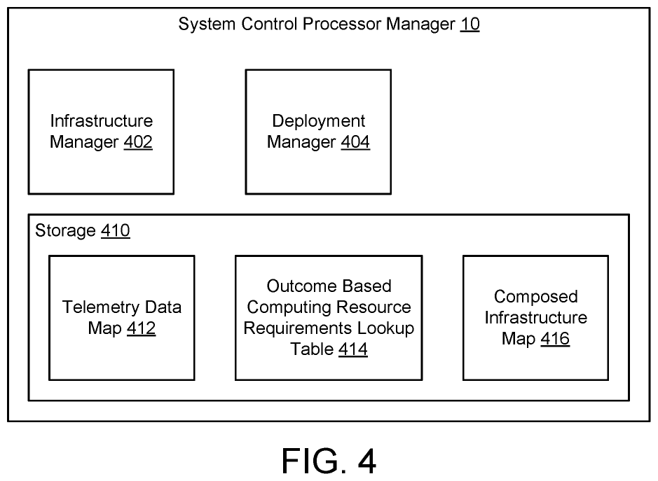

Additionally, by composing composed information handling systems in this manner, the control resource set of each composed information handling system may be used to consistently deploy management services across any number of composed information handling systems. Consequently, embodiments of the invention may provide a framework for unified security, manageability, resource management/composability, workload management, and distributed system management by use of this three-resource set model. For example, entities tasked with monitoring the health of computing resources of the composed information handling systems may be deployed in control resource sets. Accordingly, the health of these computing resources for providing computer implemented services requested by the clients may be uniformly monitored across the information handling systems (60). For additional details regarding the system control processor manager (50), refer to FIG. 4.

In one or more embodiments of the invention, a composed information handling system is a device that is formed using all, or a portion, of the computing resources of the information handling systems (60), the external resources (30), and/or other types of hardware devices operably connected to the information handling systems (60). The composed information handling system may utilize the computing resources allocated to it to provide computer implemented services. For example, the composed information handling system may host one or more applications that utilize the computing resources assigned to the composed information handling system. The applications may provide the computer implemented services. Thus, the quality of the computer implemented services may be limited based on the allocation of computing resources to the composed information handling systems.

To instantiate composed information handling systems, the information handling systems (60) may include at least three resource sets including a control resource set. The control resource set may include a system control processor. The system control processor of each information handling system may coordinate with the system control processor manager (50) to enable composed information handling systems to be instantiated. For example, the system control processor of an information handling system may provide telemetry data regarding the computing resources of an information handling system, may perform actions on behalf of the system control processor manager (50) to aggregate computing resources together, may monitor the utilization and/or health of computing resources for providing computer implemented services requested by the client, and/or may provide services that unify the operation of composed information handling systems.

In one or more embodiments of the invention, compute resource sets of composed information handling systems are presented with bare metal resources by control resource sets even when the presented resources are actually being managed using one or more layers of abstraction such as emulation, virtualization, indirection, security model, data integrity model, etc. For example, the system control processors of the control resource sets may provide the abstraction, emulation, virtualization, indirection, and/or other services while presenting the resources as bare metal resources. Consequently, these services may be transparent to applications hosted by the compute resource sets of composed information handling systems thereby enabling uniform deployment of such services without requiring implementation of control plane entities hosted by the compute resource sets of the composed information handling systems. Accordingly, by utilizing system control processors to monitor the health of the computing resources of a composed information handling system, applications or other entities hosted by the composed information handling system may not be able to view, be aware, impact, or otherwise influence the collection of computing resource health data. Accordingly, relevant information that may be used to decide how to manage computing resources for health management purposes may be obtain in a manner that is transparent to the composed information handling systems. For additional details regarding the information handling systems (60), refer to FIG. 1.2.

The external resources (30) may provide computing resources that may be allocated for use by composed information handling systems. For example, the external resources (30) may include hardware devices that provide any number and type of computing resources. The composed information handling system may use these resource to provide their functionalities. For example, system control processors may operably connect to and manage the external resources (30) to provide additional and/or different computing resources from those available to be provided only using hardware resource sets of information handling systems. By utilizing system control processors to manage these resources, the use of these external resources (30) for providing services requested by the clients may also be efficiently and transparently monitored.

Different external resources (e.g., 32, 34) may provide similar or different computing resources. For example, some external resources may include large numbers of hard disk drives to provide storage resources while other may include graphics processing unit rendering farms. The external resources (30) may include any number and type of computing resources for allocation to composed information handling systems via system control processors of control resource sets.

The system of FIG. 1.1 may include any number of information handling systems (e.g., 62, 64), any number of external resources (e.g., 32, 34), and any number of system control processor managers (e.g., 50). Any of the components of FIG. 1.1 may be operably connected to any other component and/or other components not illustrated in FIG. 1.1 via one or more networks (e.g., 130). The networks may be implemented using any combination of wired and/or wireless network topologies.

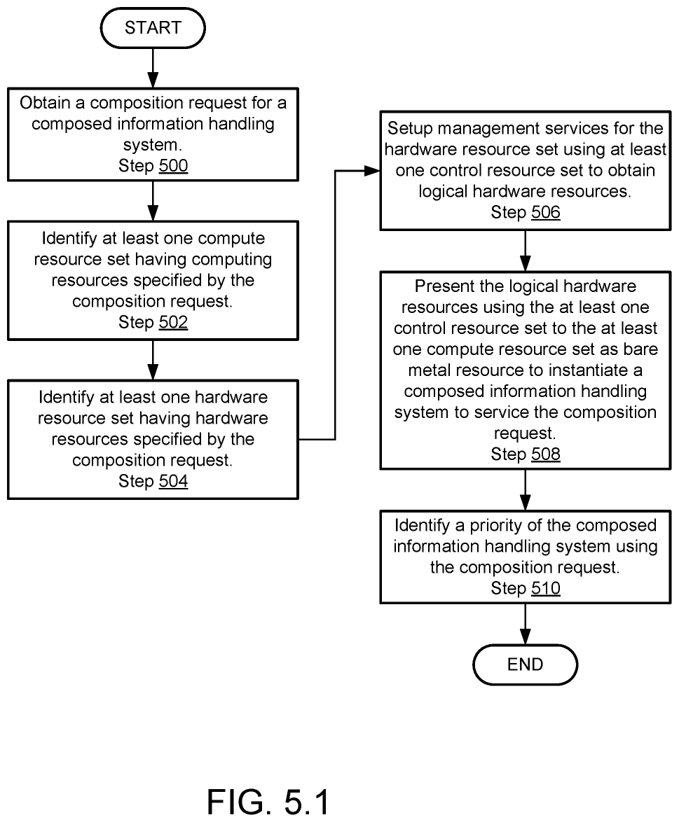

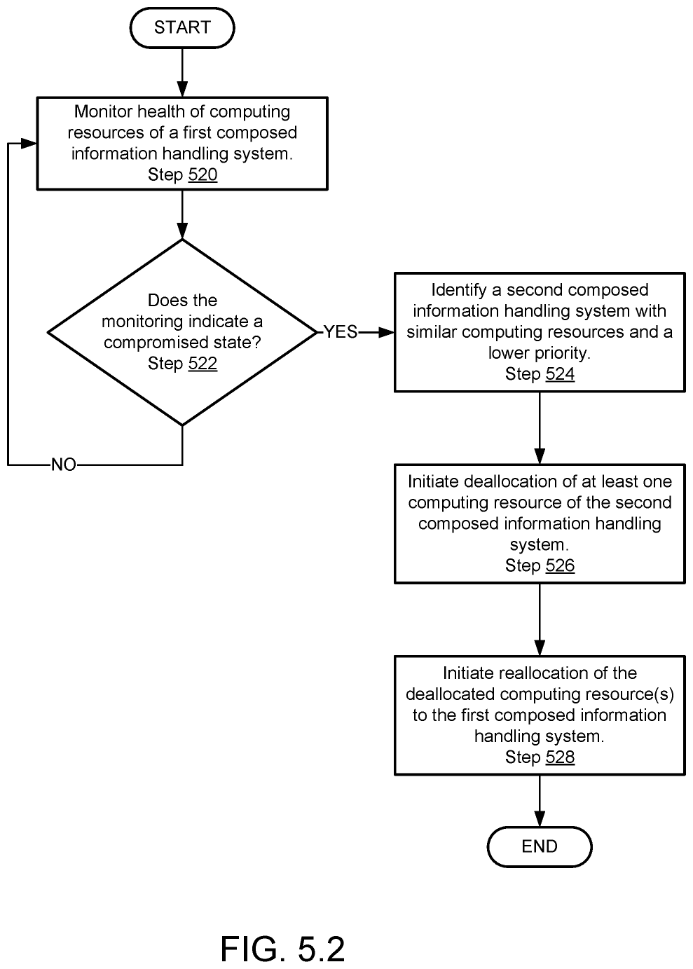

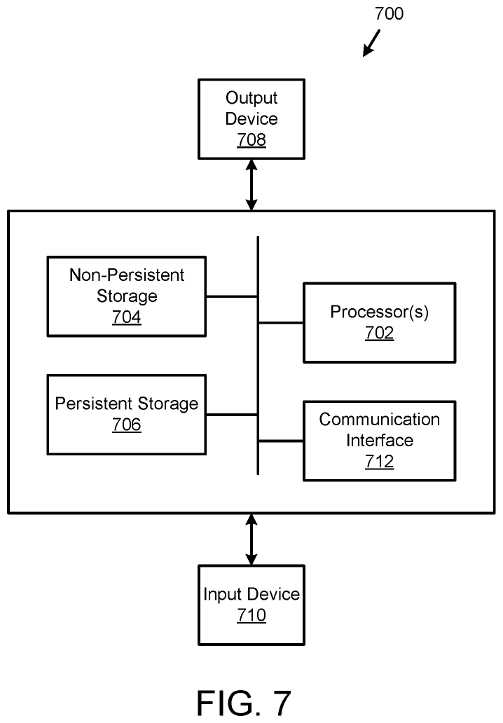

The system control processor manager (50), information handling systems (60), and/or external resources (30) may be implemented using computing devices. The computing devices may include, for example, a server, laptop computer, a desktop computer, a node of a distributed system, etc. The computing device may include one or more processors, memory (e.g., random access memory), and/or persistent storage (e.g., disk drives, solid state drives, etc.). The persistent storage may store computer instructions, e.g., computer code, that (when executed by the processor(s) of the computing device) cause the computing device to perform the functions of the system control processor manager (50), information handling systems (60), and/or external resources (30) described in this application and/or all, or a portion, of the methods illustrated in FIGS. 5.1-5.2. The system control processor manager (50), information handling systems (60), and/or external resources (30) may be implemented using other types of computing devices without departing from the invention. For additional details regarding computing devices, refer to FIG. 7.

While the system of FIG. 1.1 has been illustrated and described as including a limited number of specific components, a system in accordance with embodiments of the invention may include additional, fewer, and/or different components without departing from the invention.

Turning to FIG. 1.2, FIG. 1.2 shows a diagram of an information handling system (100) in accordance with one or more embodiments of the invention. Any of the information handling systems (e.g., 60) of FIG. 1.1 may be similar to the information handling system (100) illustrated in FIG. 1.2.

As discussed above, the information handling system (100) may provide any quantity and type of computer implemented services. To provide the computer implemented services, resources of the information handling system may be used to instantiate one or more composed information handling systems. The composed information handling systems may provide the computer implemented services.

To provide computer implemented services, the information handling system (100) may include any number and type of hardware devices including, for example, one or more processors (106), any quantity and type of processor dedicated memory (104), one or more system control processors (114), and any number of hardware resources (118). These hardware devices may be logically divided into three resource sets including a compute resource set (102), a control resource set (108), and a hardware resource set (110).

The control resource set (108) of the information handling system (100) may facilitate formation of composed information handling systems, monitoring of the health of computing resources utilized by the composed information handling systems, and/or recomposition of the computing resources. To do so, the control resource set (108) may prepare any quantity of resources from any number of hardware resource sets (e.g., 110) (e.g., of the information handling system (100) and/or other information handling systems) for presentation to processing resources of any number of computing resource sets (e.g., 102) (e.g., of the information handling system (100) and/or other information handling systems). Once prepared, the control resource set (108) may present the prepared resources as bare metal resources to the processors (e.g., 106) of the allocated computing resources. By doing so, a composed information handling system may be instantiated.

To prepare the resources of the hardware resource sets for presentation, the control resource set (108) may employ, for example, virtualization, indirection, abstraction, and/or emulation. These management functionalities may be transparent to applications hosted by the resulting instantiated composed information handling systems. Consequently, while unknown to the control plane entities of the composed information handling system, the composed information handling system may operate in accordance with any number of management models thereby providing for unified control and management of composed information handling systems. These functionalities may be transparent to applications hosted by composed information handling systems thereby relieving them from overhead associated with these functionalities.

For example, consider a scenario where a compute resource set is instructed to instantiate a composed information handling system including a compute resource set and a hardware resource set that will contribute storage resources to the compute resource set. The compute resource set may virtualize the storage resources of the hardware resource set to enable a select quantity of the storage resources to be allocated to the composed information handling system while reserving some of the storage resources for allocation to other composed information handling systems. However, the prepared storage resources may be presented to the compute resource set as bare metal resources. Consequently, the compute resource set may not need to host any control plane entities or otherwise incur overhead for utilizing the virtualized storage resources (e.g., the compute resource set may send bare metal communications to the control resource set, the control resource set may translate those bare metal communications into prepared resource compatible communications, and the control resource set may send the prepared resource compatible communications to the hardware resource set).

The control resource set (108) may also enable the utilization of any of the hardware components of the information handling system (100) by respective clients. When a composed information handling system is instantiated, it (and its hardware devices) may be utilized by a client by enabling the client to load application onto the composed information handling system. For example, the client may cause the composed information handling system to execute applications on the compute resource set (102) which, in turn, may utilize any number of hardware resource sets (e.g., 110) as part of their execution.

Because the control resource set (108) may mediate utilization of hardware resource sets (110) by compute resource sets (102), the control resource set (108) may transparently ascertain the health of the hardware devices of these resource sets. To do so, the control resource set (108) may (i) intercept (as part of presenting computing resources of hardware resource sets to compute resource sets) communications between resource sets which may be used to infer the health of these hardware devices and explicitly monitor the health of these hardware devices by invoking health functions of these devices (e.g., health reporting functions, diagnostic functions, etc.).

The collected health information may be used, for example, to ascertain whether any of the computing resources provided by any number of hardware devices should be recomposed. In one or more embodiments of the invention, recomposing computing resources means changing all or a portion of the hardware devices used to provide the computing resources.

For example, consider a scenario where at a first point in time a control resource set is presenting storage resources to a computing resource set using a hard disk drive of a hardware resource set. If the hard disk drive fails, the control resource set may no longer be able to present the computing resources using the hard disk drive. To reduce the likelihood that this scenario will occur and, based on health monitoring of the hard disk drive, the control resource set may identify that the hard disk drive may be likely to fail. In response to the determination, the control resource set may request that the storage resource be recomposed. A system control processor manager may identify free storage that may be used to replace the likely to fail hard disk drive. The free storage resources may be allocated to the composed information handling system. The control resource set may migrate the data to the newly allocated free storage resources and begin presenting the new storage resources as the storage resources to the compute resource set. The likely to fail hard disk drive may then be deallocated from the composed information handling system. By doing so, storage resources may be continuously presented to the computing resource set (102) in a transparent manner even though different hardware devices have been utilized overtime to provide the storage resources.

The processors (106) of the compute resource set (102) may be operably connected to one or more system control processors (114) of the control resource set (108). For example, the processors (106) may be connected to a compute resource interface (112), which is also connected to the system control processors (114). The compute resource interface (112) may enable the processors (106) to communicate with other entities via bare metal communications. Also, the compute resource interface (112) may enable system control processors (114) of the control resource set (108) to monitor the activity and/or health of the processors (106) and/or processor dedicated memory (104) to identify use of these hardware devices by clients. For example, the compute resources interface (112) may support sideband communications to the hardware devices of the compute resource set (102) thereby enabling health information for these hardware devices to be obtained by the system control processors (114).

The system control processors (114) of the control resource set (108) may present computing resources to the processors (106) as bare metal resources. In other words, from the point of view of the processors (106), any number of bare metal resources may be operably connected to it via the compute resources interface (112) when, in reality, the system control processors (114) are operably connected to the processors (106) via the compute resources interface (112). In other words, the system control processors (114) may manage presentation of other types of resources (e.g., computing resources of the hardware resource set (110), external resources, other hardware resource sets of other information handling systems, etc.) to the compute resource set (102).

By presenting the computing resources to the processors as bare metal resources, control plane entities (e.g., applications) such as hypervisors, emulators, and/or other types of management entities may not need to be hosted (e.g., executed) by the processors (106) for the processors (106) and entities hosted by them to utilize the computing resources allocated to a composed information handling system. Accordingly, all of the processing resources provided by the compute resource set (102) may be dedicated to providing the computer implemented services.

For example, the processors (106) may utilize mapped memory addresses to communicate with the bare metal resources presented by the system control processors (114) to the processors (106). The system control processors (114) may obtain these communications and appropriately remap (e.g., repackage, redirect, encapsulate, etc.) the communications to the actual hardware devices providing the computing resources, which the processors (106) are interacting with via the compute resources interface (112) and/or hardware resources interface (116), discussed below. Consequently, indirection, remapping, and/or other functions required for resource virtualization, emulation, abstraction, or other methods of resource allocation (other than bare metal) and management may not need to be implemented via the processors (106).

By doing so, any number of functions for a composed information handling system may be automatically performed in a manner that is transparent to the control plane. Accordingly, a composed information handling system may operate in a manner consistent with a unified, consistent architecture or model (e.g., communications model, data storage model, etc.) by configuring the operation of one or more system control processors in a manner consistent with the architecture or model.

In one or more embodiments of the invention, control plane entities utilize computing resources presented through one or more layers of indirection, abstraction, virtualization, etc. In other words, an indirect use of hardware devices and computing resources provided thereby. In the information handling system of FIG. 1.2, the system control processors (114) may present abstracted resources, indirection layers, virtualization layers, etc. as bare metal resources,

In one or more embodiments of the invention, data plane entities directly utilize computing resources. For example, data plane entities may instruct hardware devices on their operation thereby directly utilizing computing resources provided thereby. Data plane entities may present the computing resources to control plane entities using one or more layers of indirection, abstraction, virtualization, etc.

The system control processors (114) may present any number of resources operably connected to it (e.g., the hardware resource set (110), other resources operably connected to it via an interface (e.g., hardware resources interface (116), etc.) as bare metal resources to the processors (106) of the compute resource set (102). Consequently, the system control processors (114) may implement device discovery processes compatible with the processors (106) to enable the processors (106) to utilize the presented computing resources.

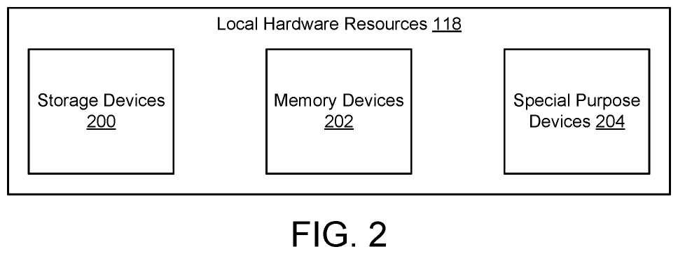

For example, the hardware resource set (110) may include hardware resources (118) operably connected to the system control processors (114) via a hardware resources interface (116). The hardware resources (118) may include any number and type of hardware devices that provide computing resources. For additional details regarding the hardware resources (118), refer to FIG. 2.

In another example, the system control processors (114) may be operably connected to other hardware resource sets of other information handling systems via hardware resources interface (116), network (130), and/or other system control processors of the other information handling systems. The system control processors may cooperatively enable hardware resource sets of other information handling systems to be prepared and presented as bare metal resources to the compute resource set (102).

In an additional example, the system control processors (114) may be operably connected to external resources via hardware resources interface (116) and network (130). The system control processors (114) may prepare and present the external resources as bare metal resources to the compute resource set (102).

The system control processors (114), by presenting resources to the compute resource set (102), may be able to monitor the utilization of the presented resources in a manner that is transparent to the applications or other entities executing using the processors (106). Consequently, these entities may not be able to interfere with monitoring of the health of these resources. In contrast, if an agent or other entity for monitoring computing resource health is executing using the processors (106), other entities executing using the processors (106) may be able to interfere with the operation of the monitoring entity. Accordingly, embodiments of the invention may provide a method of monitoring computing resources health that is less susceptible to interference by other entities. By doing so, recomposition decisions made based on the collected information and may better reflect the actual health of resources of the composed information handling systems.

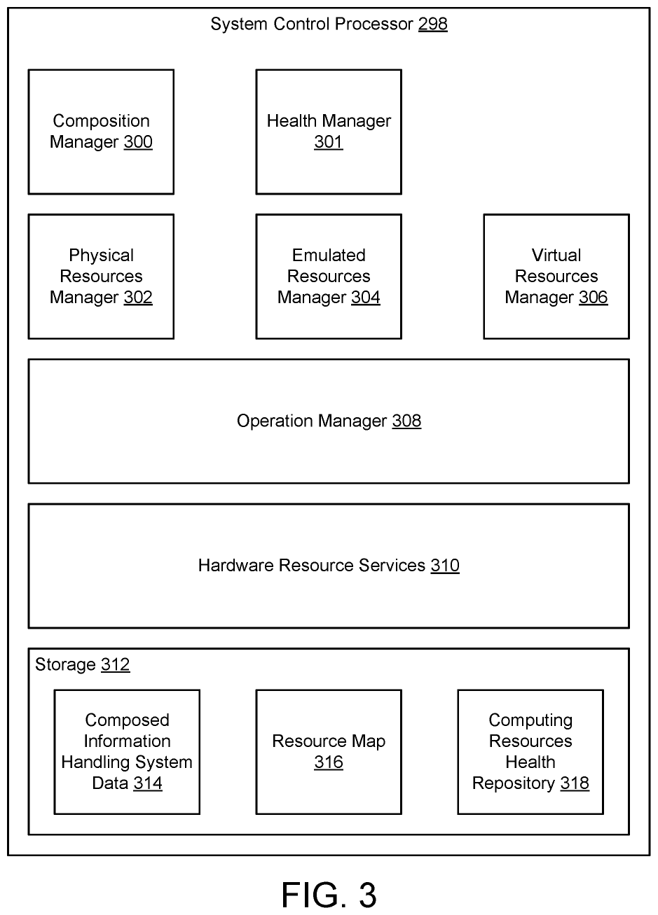

For additional details regarding the operation and functions of the system control processors (114), refer to FIG. 3.

The compute resources interface (112) may be implemented using any suitable interconnection technology including, for example, system buses such as compute express links or other interconnection protocols. The compute resources interface (112) may support any input/output (IO) protocol, any memory protocol, any coherence interface, etc. The compute resources interface (112) may support processor to device connections, processor to memory connections, and/or other types of connections. The compute resources interface (112) may be implemented using one or more hardware devices including circuitry adapted to provide the functionality of the compute resources interface (112).

The compute resources interface (112) may also support sideband communications between the system control processors (114), the processors (106), and/or the processor dedicated memory (104). Consequently, the system control processors (114) may be able to monitor the operations of these other devices to identify the utilization of these hardware devices by clients, identify workloads being performed by these devices, etc.

The hardware resources interface (116) may be implemented using any suitable interconnection technology including, for example, system buses such as compute express links or other interconnection protocols. The hardware resources interface (116) may support any input/output (TO) protocol, any memory protocol, any coherence interface, etc. The hardware resources interface (116) may support processor to device connections, processor to memory connections, and/or other types of connections. The hardware resources interface (116) may be implemented using one or more hardware devices including circuitry adapted to provide the functionality of the hardware resources interface (116).

In some embodiments of the invention, the compute resource set (102), control resource set (108), and/or hardware resource set (110) may be implemented as separate physical devices. In such a scenario, the compute resources interface (112) and hardware resources interface (116) may include one or more networks enabling these resource sets to communicate with one another. Consequently, any of these resource sets (e.g., 102, 108, 110) may include network interface cards or other devices to enable the hardware devices of the respective resource sets to communicate with each other.

In one or more embodiments of the invention, the system control processors (114) support multiple, independent connections. For example, the system control processors (114) may support a first network communications connection (e.g., an in-band connection) that may be allocated for use by applications hosted by the processors (106). The system control processors (114) may also support a second network communications connection (e.g., an out-of-band connection (not shown)) that may be allocated for use by applications hosted by the system control processors (114). The out-of-band connection may be utilized for management and control purposes while the in-band connection may be utilized to provide computer implemented services. These connections may be associated with different network endpoints thereby enabling communications to be selectively directed toward applications hosted by the processors (106) and/or system control processors (114). As will be discussed in greater detail with respect to FIG. 3, the system control processors (114) may utilize the out-of-band connections to communicate with other devices to manage (e.g., instantiate, monitor, modify, identify health issues, recompose computing resources thereof, etc.) composed information handling systems.

The network (130) may correspond to any type of network and may be operably connected to the Internet or other networks thereby enabling the information handling system (100) to communicate with any number and type of other devices.

The information handling system (100) may be implemented using computing devices. The computing devices may be, for example, a server, laptop computer, desktop computer, node of a distributed system, etc. The computing device may include one or more processors, memory (e.g., random access memory), and/or persistent storage (e.g., disk drives, solid state drives, etc.). The persistent storage may store computer instructions, e.g., computer code, that (when executed by the processor(s) of the computing device) cause the computing device to perform the functions of the information handling system (100) described in this application and/or all, or a portion, of the methods illustrated in FIGS. 5.1-5.2. The information handling system (100) may be implemented using other types of computing devices without departing from the invention. For additional details regarding computing devices, refer to FIG. 7.

While the information handling system (100) has been illustrated and described as including a limited number of specific components, an information handling system in accordance with embodiments of the invention may include additional, fewer, and/or different components without departing from the invention.

Turning to FIG. 2, FIG. 2 shows a diagram the hardware resources (118) in accordance with one or more embodiments of the invention. As noted above, system control processors of information handling systems may present resources including, for example, some of the hardware resources (118) to form a composed information handling system.

The hardware resources (118) may include any number and types of hardware devices that may provide any quantity and type of computing resources. For example, the hardware resources (118) may include storage devices (200), memory devices (202), and special purpose devices (204).

The storage devices (200) may provide storage resources (e.g., persistent storage) in which applications hosted by a composed information handling system may store data including any type and quantity of information. The storage devices (200) may include any type and quantity of devices for storing data. The devices may include, for example, hard disk drives, solid state drives, tape drives, etc. The storage devices (200) may include other types of devices for providing storages resources without departing from the invention. For example, the storage devices (200) may include controllers (e.g., redundant array of disk controllers), load balancers, and/or other types of devices.

The memory devices (202) may provide memory resources (e.g., transitory and/or persistent storage) in which a composed information handling system may store data including any type and quantity of information. The memory devices (202) may include any type and quantity of devices for storing data. The devices may include, for example, transitory memory such as random access memory, persistent memory such as enterprise class memory, etc. The memory devices (202) may include other types of devices for providing memory resources without departing from the invention. For example, the storage devices (200) may include controllers (e.g., replication managers), load balancers, and/or other types of devices.

The special purpose devices (204) may provide other types of computing resources (e.g., graphics processing resources, computation acceleration resources, etc.) to composed information handling systems. The special purpose devices (204) may include any type and quantity of devices for providing other types of computing resources. The special purpose devices (204) may include, for example, graphics processing units for providing graphics processing resources, compute accelerators for accelerating corresponding workloads performed by composed information handling systems, application specific integrated circuits (ASICs) for performing other functionalities, digital signal processors for facilitating high speed communications, field-programmable gate arrays (FPGAs), etc. The special purpose devices (204) may include other types of devices for providing other types of computing resources without departing from the invention.

The system control processors of the information handling systems may mediate presentation of the computing resources provided by the hardware resources (118) to computing resource sets (e.g., as bare metal resources to processors). When doing so, the system control processors may provide a layer of abstraction that enables the hardware resources (118) to be, for example, virtualized, emulated as being compatible with other systems, and/or directly connected to the compute resource sets (e.g., pass through). Consequently, the computing resources of the hardware resources (118) may be finely, or at a macro level, allocated to different composed information handling systems.

Additionally, the system control processors may manage operation of these hardware devices in accordance with one or more models including, for example, data protection models, security models, workload performance availability models, reporting models, etc. For example, the system control processors may cause multiple copies of data to be redundantly stored, to be stored with error correction code, and/or other information usable for data integrity purposes.

The manner of operation of these devices may be transparent to the computing resource sets utilizing these hardware devices for providing computer implemented services. Consequently, even though the resulting composed information handling system control plane may be unaware of the implementation of these models, the composed information handling systems may still operate in accordance with these models thereby providing a unified method of managing the operation of composed information handling systems.

Further, the system control processors may monitor the health of these hardware devices. As will be discussed below, the system control processors may host applications that monitor communications indicative of health of these hardware devices and/or directly active health reporting functionality of these devices to determine whether these devices may be operating in compromised states.

While the hardware resources (118) have been illustrated and described as including a limited number of specific components, hardware resources in accordance with embodiments of the invention may include additional, fewer, and/or different components without departing from the invention.

As discussed above, information handling systems may include system control processors that may be used to instantiate composed information handling systems. FIG. 3 shows a diagram of a system control processor (298) in accordance with one or more embodiments of the invention. Any of the system control processors included in control resources sets of FIG. 1.2 may be similar to the system control processor (298) illustrated in FIG. 3.

The system control processor (298) may facilitate instantiation, reallocation of resources to/from composed systems, and operation of composed information handling systems. By doing so, a system that includes information handling systems may dynamically instantiate and recompose (e.g., add/remove/replace resources) composed information handling systems to provide computer implemented services.

To instantiate and operate composed information handling systems, the system control processor (298) may include a composition manager (300), a health manager (301), a physical resources manager (302), an emulated resources manager (304), a virtual resources manager (306), an operation manager (308), hardware resource services (310), and storage (312). Each of these components of the system control processor is discussed below.

The composition manager (300) may manage the process of instantiating and operating composed information handling systems. To provide these management services, the composition manager (300) may include functionality to (i) obtain information regarding the hardware components of the information handling system (e.g., obtain telemetry data regarding the information handling system), (ii) provide the obtained information to other entities (e.g., management entities such as system control processor manager (50, FIG. 1.1)), (iii) obtain composition/recomposition requests for composed information handling systems, (iv) based on the composition requests, prepare and present resources as bare metal resources to compute resource sets, (v) instantiate applications in composed information handling systems to cause the composed information handling systems to provide computer implemented services, conform their operation to security models, etc., (vi) add/remove/recompose resources presented to the compute resource sets of composed information handling systems dynamically in accordance with health states of the resources, and/or (vii) coordinate with other system control processors to provide distributed system functionalities and/or transfer performance of applications and/or computer implemented services between composed information handling systems. By providing the above functionalities, a system control processor in accordance with one or more embodiments of the invention may enable distributed resources from any number of information handling systems to be aggregated into a composed information handling system to provide computer implemented services meeting the expectations of clients.

To obtain information regarding the hardware components of the information handling system, the composition manager (300) may inventory the components of the information handling system hosting the system control processor. The inventory may include, for example, the type and model of each hardware component, versions of firmware or other code executing on the hardware components, and/or information regarding hardware components of the information handling system that may be allocated to form composed information handling systems.

The composition manager (300) may obtain composition requests from other entities (e.g., management entities tasked with instantiating composed information handling systems), as pre-loaded instructions present in storage of the system control processor, and/or via other methods. The composition requests may specify, for example, the types and quantities of computing resources to be allocated to a composed information handling system.

In one or more embodiments of the invention, the composition requests specify the computing resource allocations using an intent-based model. For example, rather than specifying specific hardware devices (or portions thereof) to be allocated to a particular compute resource set to obtain a composed information handling system, the resource requests may only specify that a composed information handling system is to be instantiated having predetermined characteristics, that a composed information handling system will perform certain workloads or execute certain applications, and/or that the composed information handling system be able to perform one or more predetermined functionalities. In such a scenario, the composition manager may decide how to instantiate the composed information handling system (e.g., which resources to allocate, how to allocate the resources (e.g., virtualization, emulation, redundant workload performance, data integrity models to employ, etc.), to which compute resource set(s) to present corresponding computing resources, etc.).

In one or more embodiments of the invention, the composition requests specify the computing resource allocations using an explicit model. For example, the composition requests may specify (i) the resources to be allocated, (ii) the manner of presentation of those resources (e.g., emulating a particular type of device using a virtualized resource vs. path through directly to a hardware component), and (iii) the compute resource set(s) to which each of the allocated resources are to be presented.

In addition to specifying resource allocations, the composition requests may also specify, for example, applications to be hosted by the composed information handling systems, security models to be employed by the composed information handling systems, communication models to be employed by the composed information handling systems, services to be provided to the composed information handling systems, user/entity access credentials for use of the composed information handling systems, and/or other information usable to place the composed information handling systems into states in which the composed information handling systems provide desired computer implemented services.

To prepare and present resources to compute resource sets based on the composition requests, the system control processors may implement, for example, abstraction, indirection, virtualization, mapping, emulation, and/or other types of services that may be used to present any type of resources as a resource that is capable of bare metal utilization by compute resource sets. To provide these services, the composition manager (300) may invoke the functionality of the physical resources manager (302), the emulated resources manager (304), and/or the virtual resources manager (306).

When presenting the resources to the compute resource sets, the system control processor (298) may present the resources using an emulated data plane. For example, the system control processors (298) may receive bare metal communications (e.g., IO from the processors) and respond in a manner consistent with responses of corresponding bare metal devices (e.g., memory, storages, network interface cards, etc.). When doing so, the system control processor (298) may translate the communications into actions. The actions may be provided to the hardware devices used by the system control processor (298) to present the bare metal resources to the compute resource set(s). In turn, the hardware devices may perform the actions which results in a composed information handling system providing desired computer implemented services.

In some scenarios, multiple system control processors may cooperate to present bare metal resources to a compute resource set. For example, a single information handling system may not include sufficient hardware devices to present a quantity and/or type of resources to a compute resource set as specified by a composition requests (e.g., present two storage devices to a compute resource set when a single information handling system only includes a single storage device). In this scenario, a second system control processor of a second information handling system operably connected to the system control processor tasked with presenting the resources to a compute resource set may prepare one of its storage devices for presentation. Once prepared, the second system control processor may communicate with the system control processor to enable the system control processor to present the prepared storage device (i.e., the storage device in the information handling system) to the compute resource set. By doing so, resources from multiple information handling system may be aggregated to present a desired quantity of resources to compute resource set(s) to form a composed information handling system.

By forming composed information handling systems as discussed above, embodiments of the invention may provide a system that is able to effectively utilize distributed resources across a range of devices to provide computer implemented services.

In addition to instantiating composed information handling systems, the composition manager (300) may service recomposition requests from, for example, the health manager (301). A recomposition request may specify that some of the computing resources of a composed information handling system should be modified to utilize other hardware devices for providing computing resources to the composed information handling system. To service recomposition requests, the composition manager (300) may identify corresponding free resources, allocate them to a composed information handling system, and deallocate the hardware devices replaced by the free resources. Once identified, the composition manager (300) may generate and send corresponding instructions to a system control processor of the composed information handling system.

When providing its functionality, the composition manager (300) may perform all, or a portion, of the methods illustrated in FIGS. 5.1-5.2

After a composed information handling system is formed, a client may begin to utilize the hardware devices of the composed information handling system by causing desired computer implemented services to be provided using the hardware devices. The health manager (301) may monitor the health of these hardware devices by the client to ascertain whether the services provided using these hardware devices meet the expectations of the client. For example, if a hardware device is likely to enter a compromised state, the computer implemented services provided by a composed information handling system may no longer be able to meet the client's expectations.

To do so, the health manager (301) may monitor the health of the hardware devices used to provide computing resources to the composed information handling system. If the health manager (301) identifies, based on its monitoring, that one or more hardware devices are likely to fail, the health manager (301) may generate and send a recomposition request to a composition manager (300). Consequently, the likely to fail hardware devices may be replaced prior to failure of the hardware devices. Accordingly, desirable computer implemented services may continue to be provided by the composed information handling system.

In one or more embodiments of the invention, the health manager (301) invokes native health reporting functionality of hardware devices when providing its functionality. By doing so, the health manager (301) may obtain information indicating the relatively likelihood of the hardware devices being able to continue to supply computing resources.

In one or more embodiments of the invention, the health manager (301) utilizes intercepted bare metal communications from compute resource sets when providing its functionality. For example, when the system control processor (298) mediates presentations of resources, it may obtain bare metal communications. The health manager (301) may review the content of these communications to ascertain whether hardware devices may be likely to enter compromised states. To do so, the health manager (301) may look for duplicative requests, delays between requests and responses, and/or other indications that a hardware device may not be operating nominally (e.g., as expected, within an accepted range, etc.). By doing so, the health manager (301) may obtain information indicating the relatively likelihood of the hardware devices being able to continue to supply computing resources.

When providing its functionality, the health manager (301) may perform all, or a portion, of the methods illustrated in FIGS. 5.1-5.2.

The physical resources manager (302) may manage presentation of resources to compute resource sets. For example, the physical resources manager (302) may generate, for example, translation tables that specify actions to be performed in response to bare metal communications obtained from compute resource sets. The translation tables may be used to take action in response to communications from compute resource sets.

The physical resources manager (302) may generate the translation tables based on the components of the compute resource sets, allocations or other types of commands/communications obtained from the compute resource sets, and the resources of the information handling system(s) allocated to service the compute resource set. For example, when a compute resource set is presented with a bare metal resource, it may go through a discovery process to prepare the bare metal resource for use. As the discovery process proceeds, the compute resource set may send commands/communications to the bare metal resource to, for example, discover its address range. The physical resources manager (302) may monitor this process, respond appropriately, and generate the translation table based on these commands and the resources available to service these bare metal commands/communications (e.g., to obtain address translation tables, emulation tables, etc.).

For example, consider a scenario where a virtualized disk is allocated to service bare metal storage commands from a compute resource set. In such a scenario, the physical resources manager (302) may generate a translation table that translates physical write from the compute resource set to virtualized writes corresponding to the virtualized disk. Consequently, the virtualized disk may be used by the system control processor (298) to present bare metal resources to the compute resource set.

The emulated resources manager (304) may generate emulation tables that enable resources that would otherwise be incompatible with a compute resource set to be compatible with the compute resource set. Different types of hardware devices of a compute resource set may be compatible with different types of hardware devices. Consequently, resources allocated to provide bare metal resources may not necessarily be compatible with the hardware devices of a compute resource set. The emulated resources manager (304) may generate emulation tables that map bare metal communications obtained from a compute resource set to actions that are compatible with resources allocated to provide bare metal resources to the compute resource sets.

The virtual resources manager (306) may manage virtualized resources that may be allocated to provide bare metal resources to compute resource sets. For example, the virtual resources manager (306) may include hypervisor functionality to virtualized hardware resources and allocate portions of the virtualized resources for use in providing bare metal resources.

While the physical resources manager (302), emulated resources manager (304), and virtual resources manager (306) have been described as generating tables, these components of the system control processor may generate other types of data structures or utilize different management models to provide their respective functionalities without departing from the invention.

The functionalities of the physical resources manager (302), emulated resources manager (304), and virtual resources manager (306) may be utilized in isolation and/or combination to provide bare metal resources to compute resource sets. By doing so, the system control processor (298) may address compatibility issues, sizing issues to match available resources to those that are to be allocated, and/or other issues to enable bare metal resources to be presented to compute resource sets.

When providing bare metal resources, the composition manager (300) may invoke the functionality of the physical resources manager (302), emulated resources manager (304), and virtual resources manager (306). Consequently, resources may be presented as bare metal resources via pass-through (i.e., forwarding IO from compute resource sets to hardware devices), bare metal resource addressing of virtualized resources, and/or as emulated resources compatible with the hardware components of the compute resource set.

The functionality of the physical resources manager (302), emulated resources manager (304), and virtual resources manager (306) may be invoked using any communication model including, for example, message passing, state sharing, memory sharing, etc.

The operation manager (308) may manage the general operation of the system control processor (298). For example, the operation manager (308) may operate as an operating system or other entity that manages the resources of the system control processor (298). The composition manager (300), health manager (301), physical resources manager (302), emulated resources manager (304), virtual resources manager (306), and/or other entities hosted by the system control processor (298) may call or otherwise utilize the operation manager (308) to obtain appropriate resources (e.g., processing resources, memory resources, storage, communications, etc.) to provide their functionalities.

The hardware resource services (310) may facilitate use of the hardware components of any number of hardware resource sets (e.g., 110, FIG. 1.2). For example, the hardware resource services (310) may include driver functionality to appropriately communicate with the hardware devices of hardware resource sets. The hardware resource services (310) may be invoked by, for example, the operation manager (308).

When providing their functionalities, any of the aforementioned components of the system control processor (298) may perform all, or a portion, methods illustrated in FIGS. 5.1-5.2

The system control processor (298) may be implemented using computing devices. The computing devices may be, for example, an embedded computing device such as a system on a chip, a processing device operably coupled to memory and storage, or another type of computing device. The computing device may include one or more processors, memory (e.g., random access memory), and/or persistent storage (e.g., disk drives, solid state drives, etc.). The persistent storage may store computer instructions, e.g., computer code, that (when executed by the processor(s) of the computing device) cause the computing device to perform the functions of the system control processor (298) described in this application and/or all, or a portion, of the methods illustrated in FIGS. 5.1-5.2. The system control processor (298) may be implemented using other types of computing devices without departing from the invention. For additional details regarding computing devices, refer to FIG. 7.

In one or more embodiments of the invention, the system control processor (298) is implemented as an on-board device. For example, the system control processor (298) may be implemented using a chip including circuitry disposed on a circuit card. The circuit card may also host the compute resource sets and/or hardware resource sets managed by the system control processor (298).

In one or more embodiments of the invention, any of the composition manager (300), health manager (301), physical resources manager (302), emulated resources manager (304), virtual resources manager (306), operation manager (308), and/or hardware resource services (310) are implemented using a hardware device including circuitry. The hardware device may be, for example, a digital signal processor, a field programmable gate array, or an application specific integrated circuit. The circuitry may be adapted to cause the hardware device to perform the functionality of the composition manager (300), health manager (301), physical resources manager (302), emulated resources manager (304), virtual resources manager (306), operation manager (308), and/or hardware resource services (310). The composition manager (300), health manager (301), physical resources manager (302), emulated resources manager (304), virtual resources manager (306), operation manager (308), and/or hardware resource services (310) may be implemented using other types of hardware devices without departing from the invention.

In one or more embodiments of the invention, any of the composition manager (300), health manager (301), physical resources manager (302), emulated resources manager (304), virtual resources manager (306), operation manager (308), and/or hardware resource services (310) are implemented using a processor adapted to execute computing code stored on a persistent storage (e.g., as part of the system control processor (298) or operably connected to the system control processor (298) thereby enabling processors of the system control processor (298) to obtain and execute the computing code) that when executed by the processor performs the functionality of the composition manager (300), health manager (301), physical resources manager (302), emulated resources manager (304), virtual resources manager (306), operation manager (308), and/or hardware resource services (310). The processor may be a hardware processor including circuitry such as, for example, a central processing unit or a microcontroller. The processor may be other types of hardware devices for processing digital information without departing from the invention.

As used herein, an entity that is programmed to perform a function (e.g., step, action, etc.) refers to one or more hardware devices (e.g., processors, digital signal processors, field programmable gate arrays, application specific integrated circuits, etc.) that provide the function. The hardware devices may be programmed to do so by, for example, being able to execute computer instructions (e.g., computer code) that cause the hardware devices to provide the function. In another example, the hardware device may be programmed to do so by having circuitry that has been adapted (e.g., modified) to perform the function. An entity that is programmed to perform a function does not include computer instructions in isolation from any hardware devices. Computer instructions may be used to program a hardware device that, when programmed, provides the function.

In one or more embodiments disclosed herein, the storage (312) is implemented using physical devices that provide data storage services (e.g., storing data and providing copies of previously stored data). The devices that provide data storage services may include hardware devices and/or logical devices. For example, storage (312) may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage (312) may include a memory device (e.g., a dual in line memory device) in which data is stored and from which copies of previously stored data are provided. In another example, storage (312) may include a persistent storage device (e.g., a solid-state disk drive) in which data is stored and from which copies of previously stored data is provided. In a still further example, storage (312) may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

The storage (312) may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage (312) may store data structures including, for example, composed information handling system data (314), a resource map (316), and a computing resources health repository (318). Each of these data structures is discussed below.

The composed information handling system data (314) may be implemented using one or more data structures that includes information regarding composed information handling systems. For example, the composed information handling system data (314) may specify identifiers of composed information handling systems and resources that have been allocated to the composed information handling systems.

The composed information handling system data (314) may also include information regarding the operation of the composed information handling systems. The information may include, for example, workload performance data, resource utilization rates over time, and/or other information that may be utilized to manage the operation of the composed information handling systems.

The composed information handling system data (314) may further include information regarding management models employed by system control processors. For example, the composed information handling system data (314) may include information regarding duplicative data stored for data integrity purposes, redundantly performed workloads to meet high availability service requirements, encryption schemes utilized to prevent unauthorized access of data, etc.

The composed information handling system data (314) may be maintained by, for example, the composition manager (300). For example, the composition manager may add, remove, and/or modify information included in the composed information handling system data (314) to cause the information included in the composed information handling system data (314) to reflect the state of the composed information handling systems.

The data structures of the composed information handling system data (314) may be implemented using, for example, lists, tables, unstructured data, databases, etc. While illustrated in FIG. 3 as being stored locally, the composed information handling system data (314) may be stored remotely and may be distributed across any number of devices without departing from the invention.

The resource map (316) may be implemented using one or more data structures that include information regarding resources of the information handling system and/or other information handling systems. For example, the resource map (316) may specify the type and/or quantity of resources (e.g., hardware devices, virtualized devices, etc.) available for allocation and/or that are already allocated to composed information handling systems. The resource map (316) may be used to provide data to management entities such as system control processor managers.

The data structures of the resource map (316) may be implemented using, for example, lists, tables, unstructured data, databases, etc. While illustrated in FIG. 3 as being stored locally, the resource map (316) may be stored remotely and may be distributed across any number of devices without departing from the invention.

The resource map (316) may be maintained by, for example, the composition manager (300). For example, the composition manager (300) may add, remove, and/or modify information included in the resource map (316) to cause the information included in the resource map (316) to reflect the state of the information handling system and/or other information handling systems.

The computing resource health repository (318) may be implemented using one or more data structures that includes information regarding the health of hardware devices that provide computing resources to composed information handling systems. For example, the computing resource health repository (318) may specify operation errors, health state information, temperature, and/or other types of information indicative of the health of hardware devices.

The computing resource health repository (318) may specify the health states of hardware devices via any method. For example, the computing resource health repository (318) may indicate whether, based on the aggregated health information, that the hardware devices are or are not in compromised states. A compromised health state may indicate that the corresponding hardware device has already or is likely to, in the future, be no longer able to provide the computing resources that it has previously provided. The health state determination may be made via any method based on the aggregated health information without departing from the invention.

For example, the health state determination may be made based on heuristic information regarding previously observed relationships between health information and future outcomes (e.g., current health information being predictive of whether a hardware device will be likely to provide computing resources in the future).

The computing resource health repository (318) may be maintained by, for example, the health manager (301). For example, the health manager (301) may add, remove, and/or modify information included in the computing resource health repository (318) to cause the information included in the computing resource health repository (318) to reflect the current health of the hardware devices that provide computing resources to composed information handling systems.

The data structures of the computing resource health repository (318) may be implemented using, for example, lists, tables, unstructured data, databases, etc. While illustrated in FIG. 3 as being stored locally, the computing resource health repository (318) may be stored remotely and may be distributed across any number of devices without departing from the invention.

While the storage (312) has been illustrated and described as including a limited number and type of data, a storage in accordance with embodiments of the invention may store additional, less, and/or different data without departing from the invention.

While the system control processor (298) has been illustrated and described as including a limited number of specific components, a system control processor in accordance with embodiments of the invention may include additional, fewer, and/or different components without departing from the invention.

As discussed above, a system control processor manager may cooperate with system control processors of control resource sets to instantiate composed information handling systems by presenting computing resources from hardware resource sets to processors of compute resource sets. FIG. 4 shows a diagram of the system control processor manager (50) in accordance with one or more embodiments of the invention. The system control processor manager (50) illustrated in FIG. 4 may be an embodiment of the system control processor manager (10, FIG. 1.1) discussed above.

The system control processor manager (50) may manage the process of instantiating composed information handling systems and recomposing composed information handling systems over time. To do so, the system control processor manager (50) may include an infrastructure manager (402), deployment manager (404), and storage (410). Each of these components is discussed below.

The infrastructure manager (402) may provide composition services. Composition services may include obtaining composition/recomposition requests for composed information handling systems, determining the resources to allocate to instantiate composed information handling systems, add/remove resources to recompose composed information handling systems, manage transfers of workloads between composed information handling systems for recomposition purposes, and cooperating with system control processors to allocate the identified resources. By doing so, the infrastructure manager (402) may cause any number of computer implemented services to be provided using the composed information handling systems.

To determine the resources to allocate to new composed information handling systems, the infrastructure manager (402) may employ an intent-based model that translates an intent expressed in a composition request to one more allocations of computing resources. For example, the infrastructure manager (402) may match an expressed intent to resources to be allocated to satisfy that intent. A lookup table may specify the type, quantity, method of management, and/or other information regarding any number of computing resources that when aggregated will be able to satisfy a corresponding intent. The infrastructure manager (402) may identify resources for allocation to satisfy composition requests via other methods without departing from the invention.

To recompose composed information handling systems, the infrastructure manager (402) may add or remove resources from existing composed information handling systems or instantiate new composed information handling systems and transfer workloads from existing composed information handling systems to the new composed information handling systems. Consequently, the composed information handling systems performing the workloads may have different amounts and/or types of computing resources after being recomposed.

For example, to recompose a composed information handling system having a failed storage resource, the infrastructure manager may instruct a system control processor of the composed information handling system to allocate a new storage resource, transfer data from the failed storage resource to the new storage resource, and deallocate the failed storage resource. By doing so, composed information handling systems may be more likely to be able to continue to provide desired computer implemented services (as opposed to services that may be impeded due to compromised storage resources).

The infrastructure manager (402) may recompose infrastructure (e.g., deployments, individual composed information handling systems, etc.) in response to recomposition requests. The recomposition requests may be obtained from, for example, the deployment manager (404). As will be discussed in greater detail below, the deployment manager (404) may determine when and how computing resources of composed information handling systems should be recomposed.

To cooperate with the system control processors for composed information handling system composition and recomposition purposes, the infrastructure manager (402) may obtain telemetry data regarding the computing resources of any number of information handling systems and/or external resources that are available for allocation. The infrastructure manager (402) may aggregate this data in a telemetry data map (412) which may be subsequently used to identify resources of any number of information handling systems and/or external resources to satisfy composition and/or recomposition requests (e.g., instantiate one or more composed information handling systems to meet the requirements of the composition requests, modify resource allocations to existing composed information handling systems, etc.).

When the infrastructure manager (402) identifies the computing resources to be allocated, the infrastructure manager (402) may communicate with any number of system control processors (e.g., of control resource sets of information handling systems) to implement the identified allocations. For example, the infrastructure manager (402) may notify a system control processor of a control resource set that portions of a hardware resource set are to be allocated to a compute resource set to instantiate a composed information handling system. The system control processor may then take action (e.g., prepare the portion of the hardware resource set for presentation to a processor of the compute resource set) in response to the notification.

As composed information handling systems are instantiated and/or recomposed, the infrastructure manager (402) may add information reflecting the resources allocated to composed information handling systems, the workloads being performed by the composed information handling systems, and/or other types of information to a composed infrastructure map (416). The infrastructure manager (402) may utilize this information to, for example, decide whether computing resources should be added to or removed from composed information handling system (e.g., whether the computing resources are free for allocation or currently utilized by other entities). Consequently, computing resources may be dynamically re-provisioned.

In one or more embodiments of the invention, the infrastructure manager (402) is implemented using a hardware device including circuitry. The hardware device may be, for example, a digital signal processor, a field programmable gate array, or an application specific integrated circuit. The circuitry may be adapted to cause the hardware device to perform the functionality of the infrastructure manager (402). The infrastructure manager (402) may be implemented using other types of hardware devices without departing from the invention.

In one or more embodiments of the invention, the infrastructure manager (402) is implemented using a processor adapted to execute computing code stored on a persistent storage that when executed by the processor performs the functionality of the infrastructure manager (402). The processor may be a hardware processor including circuitry such as, for example, a central processing unit or a microcontroller. The processor may be other types of hardware devices for processing digital information without departing from the invention.

When providing its functionality, the infrastructure manager (402) may perform all, or a portion, of the methods illustrated in FIGS. 5.1-5.2.

The deployment manager (404) may provide recomposition services. Recomposition services may include (i) monitoring the health of computing resources of composed information handling systems, (ii) determining, based on the health of the computing resources, whether the computing resources are compromised, and/or (iii) initiating recomposition of computing resources that are compromised. By doing so, the deployment manager (404) may improve the likelihood that computer implemented services provided by composed information handling systems meet client expectations.

When providing recomposition services, the deployment manager (404) may receive recomposition requests from system control processors that have determined that at least some of the computing resources of a composed information handling system have been compromised. In such a scenario, the deployment manager (404) may elect to recompose the computing resources in response to the request or may delay recomposition to a later period of time. The deployment manager (404) may make the aforementioned determination based on whether the compromised computing resources are likely to prevent the composed information handling system from providing desired computer implemented services. If the compromised computing resources are unlikely to negatively impact the provided services, then the deployment manager (404) may delay initiating recomposition of the computing resources (e.g., by generating and sending an appropriate request to the infrastructure manager (402)).

In one or more embodiments of the invention, the deployment manager (404) is implemented using a hardware device including circuitry. The hardware device may be, for example, a digital signal processor, a field programmable gate array, or an application specific integrated circuit. The circuitry may be adapted to cause the hardware device to perform the functionality of the deployment manager (404). The deployment manager (404) may be implemented using other types of hardware devices without departing from the invention.

In one or more embodiments of the invention, the deployment manager (404) is implemented using a processor adapted to execute computing code stored on a persistent storage that when executed by the processor performs the functionality of the deployment manager (404). The processor may be a hardware processor including circuitry such as, for example, a central processing unit or a microcontroller. The processor may be other types of hardware devices for processing digital information without departing from the invention.

When providing its functionality, the deployment manager (404) may perform all, or a portion, of the methods illustrated in FIGS. 5.1-5.2. While illustrated and described as separate entities, the functionalities of the infrastructure manager (402) and the deployment manager (404) may be performed by a single entity (e.g., either of these entities and/or other entities) without departing from the invention.

In one or more embodiments disclosed herein, the storage (410) is implemented using physical devices that provide data storage services (e.g., storing data and providing copies of previously stored data). The devices that provide data storage services may include hardware devices and/or logical devices. For example, storage (410) may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage (410) may include a memory device (e.g., a dual in line memory device) in which data is stored and from which copies of previously stored data are provided. In another example, storage (410) may include a persistent storage device (e.g., a solid-state disk drive) in which data is stored and from which copies of previously stored data is provided. In a still further example, storage (410) may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

The storage (410) may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage (410) may store data structures including, for example, the telemetry data map (412), the outcome based computing resource requirements lookup table (414), and the composed infrastructure map (416). These data structures may be maintained by, for example, the infrastructure manager (402) and/or the deployment manager (404). For example, the infrastructure manager (402) and/or deployment manager (404) may add, remove, and/or modify information included in these data structures to cause the information included in these data structure to reflect the state of any number of information handling systems, external resources, and/or composed information handling systems.

Any of these data structures may be implemented using any combination and quantity of, for example, lists, tables, unstructured data, databases, etc. While illustrated in FIG. 4 as being stored locally, any of these data structures may be stored remotely and may be distributed across any number of devices without departing from the invention.

While the storage (410) has been illustrated and described as including a limited number and type of data, a storage in accordance with embodiments of the invention may store additional, less, and/or different data without departing from the invention.

While the system control processor manager (50) has been illustrated and described as including a limited number of specific components, a system control processor manager in accordance with embodiments of the invention may include additional, fewer, and/or different components than those illustrated in FIG. 4 without departing from the invention.

As discussed above, the system of FIG. 1.1 may provide computer implemented services using composed information handling systems. FIGS. 5.1-5.2 show methods that may be performed by components of the system of FIG. 1.1 to manage composed information handling systems.

FIG. 5.1 shows a flowchart of a method in accordance with one or more embodiments of the invention. The method depicted in FIG. 5.1 may be performed to manage the computing resources of a composed information handling system in accordance with one or more embodiments of the invention. The method shown in FIG. 5.1 may be performed by, for example, a system control processor manager (e.g., 50, FIG. 1.1). Other components of the system in FIG. 1.1 may perform all, or a portion, of the method of FIG. 5.1 without departing from the invention.

While FIG. 5.1 is illustrated as a series of steps, any of the steps may be omitted, performed in a different order, additional steps may be included, and/or any or all of the steps may be performed in a parallel and/or partially overlapping manner without departing from the invention.

In step 500, a composition request for a composed information handling system is obtained. The composition request may be obtained using any method without departing from the invention. For example, the composition request may be obtained as part of a message from another entity operably connected to a system control processor manager. In another example, the composition request may be locally stored in a storage of a system control processor manager.

The composition request may be a data structure specifying that the composed information handling system is to be instantiated. As discussed with respect to FIG. 3, the composition request may be specific (i.e., includes a listing of resources to be allocated to the composed information handling system) or intent-based (i.e., a desired outcome without specifying the resources to be allocated). The composition request may include any type and quantity of information usable to determine how to instantiate a composed information handling system.

In one or more embodiments of the invention, the composition request includes a list of computing resources to be allocated to the composed information handling system. For example, the composition request may specify computing resources, memory resources, storage resources, graphics processing resources, compute acceleration resources, communications resources, etc. The list may include any type and quantity of computing resources.

In one or more embodiments of the invention, the composition request specifies how the computing resources are to be presented. For example, the composition request may specify virtualization, emulation, etc. for presenting the computing resources.

In one or more embodiments of the invention, the composition request specifies how the resources used to present the computing resources are to be managed (e.g., a management model such as data integrity, security, management, usability, performance, etc.). For example, the composition request may specify levels of redundancy for data storage, data integrity to be employed (e.g., redundant array of independent disks (RAID), error correction code (ECC), etc.), levels of security to be employed for resources (e.g., encryption), and/or other information that specifies how system control processors are to utilize resources for presentation of resources to composed information handling systems. The methods employed by the system control processors may be transparent to the composed information handling systems because the resources may be presented to the compute resource sets of the composed information handling systems as bare metal resources while the system control processors provide the management functionality.

In one or more embodiments of the invention, the composition request includes a list of applications to be hosted by the composed information handling system. The list may include any type and quantity of applications.

The composition request may also specify the identities of one or more system control processors hosted by other devices. In some scenarios, as noted above, resources from other information handling systems may be used to form a composed information handling system. The identifiers of the system control processors of these other information handling systems may be used to form operable connections between the system control processors. These connections may be used by the system control processors to present, as bare metal resources, computing resources from other information handling systems to compute resource set(s) of the composed information handling system.

For example, a system control processor of a first information handling system may manage a storage device as a virtualized resource. The system control processor may connect to a second system control processor which, in turn, is operably connected to a compute resource set. The second control processor may operate as a pass through for the system control processor while presenting the virtualized resource as a bare metal resource to the compute resource set. Consequently, when the compute resource set attempts to communicate with the storage, the compute resource set may send a bare metal communication to the system control processor, the system control processor may relay the bare metal communication to the second system control processor, and the second system control processor may processes the bare metal communication in accordance with its virtualization model (e.g., converting a logical block address to a physical block address in accordance with the virtualization model) to instruct the storage device to perform one or more actions to satisfy the bare metal communication.

In step 502, at least one compute resource set having computing resources specified by the composition request is identified. The at least one compute resource set may be identified by matching the computing resources specified by the composition request to at least one compute resource set having those resources using a telemetry data map (412, FIG. 4).

For example, the telemetry data map (412, FIG. 4) may specify a list of compute resource sets, identifiers of control resource sets that manage the listed compute resource sets, and the hardware devices of the listed compute resource sets. By matching the computing resources specified by the composition request to the hardware devices specified in the list, the compute resource set corresponding to the listed hardware devices may be identified as the at least one compute resource set.

If no compute resource set includes all of the computing resources specified by the composition request, multiple compute resource sets having sufficient hardware devices to meet the computing resources specified by the composition request may be identified as the at least one compute resource set.

However, the at least one compute resource set may not be able to satisfy all of the computing resources specified by the composition request. As discussed above, compute resource sets may only include a limited number and type of hardware devices. Consequently, the at least one compute resource set may not be able to provide some of the computing resources (e.g., graphics processing, communications, etc.) specified by the composition request.

In step 504, at least one hardware resource set having hardware resources specified by the composition request is identified. The at least one hardware resource set may be identified similarly to that described with respect to the identified of the at least one compute resource set of step 504. For example, the computing resources requirements specified by the composition request may be matched to compute resource sets.

In step 506, management services for the at least one compute resource set and the at least one hardware resource set are setup using at least one control resource set. The management services may include, for example, virtualization, emulation, abstraction, indirection, and/or other type of services to meet the requirements of data integrity, security, and/or management models. The management services may enable bare metal communications received from a compute resource set to be converted into communications and/or action (e.g., management compatible communications) that are compatible with the management of the resources of the hardware resource set. When sent to the hardware devices, the management compatible communications may cause the hardware devices to operate in a manner consistent with how they are managed.

For example, if management services include storing multiple copies of data, multiple communications (i.e., management method compatible communications) may be generated and sent based on a bare metal communication specify that a single copy of data is to be stored. By sending the multiple communications (e.g., copies of the to-be-stored data and corresponding instructions for storing the data) to multiple hardware devices, the data may be stored in accordance with the management services. The management method compatible communications may be generated via any method without departing from the invention.

The management services may also include monitoring of the utilization of the hardware devices of the at least one compute resource set and the at least one hardware resource set. For example, the utilization monitor hosted by the system control processor of the at least one control resource set may be configured to perform the monitoring of the hardware devices of these sets. Consequently, the system may begin to monitor the use of these hardware devices by a client that sent the composition request.

As discussed above, the utilization manager may be monitoring by communicating with the hardware devices of the at least one compute resource set via sideband communication, intercept communications from the at least one computing resource set directed toward the at least one hardware resource set to identify how the hardware devices of the at least compute resource set are using the hardware devices of the at least one hardware resource set, etc. Consequently, the monitored computing resource use may be transparent to entities executing using the at least one compute resource set.

In step 508, the managed at least one hardware resources are presented to the at least one compute resource set as bare metal resources using the at least one control resource set to instantiate the composed information handling system to service the composition request.

To present the managed at least one hardware resource set, the system control processor manager may instruct the system control processors of the at least control resource set to present the managed at least one hardware resource set as discoverable bare metal resources to the at least one compute resource set. For example, the at least one control resource set may send a bare metal communication to one or more processors of the managed at least one compute resource set to cause the processors to discover the presence of the presented bare metal resources. By doing so, the processors may then begin to utilize the managed at least one hardware resource set as bare metal resources resulting in a composed information handling system having all of the resources necessary to provide desired computer implemented services.

In step 510, a priority of the composed information handling system is identified using the composition request. In one or more embodiments of the invention, the priority is specified in the composition request. In contrast, the priority may be identified using the monitoring of the computing resources performed on the composed information handling system. The monitoring may obtain a usage of the computing resources. For example, a high usage of the computing resources may correspond to a high priority, and low usage may correspond with a low priority. Additional and/or different information may be used to determine a priority of each of the composed information handling systems. Further, the invention is not limited to high and low priority characterizations; rather, any level of granularity may be used to specify a priority of the composed information handling systems.

Using the method illustrated in FIG. 5.1, computing resources of a composed information handling system may be managed in a manner that enables deallocation and reallocation based on a monitoring performed on the composed information handling system. The monitoring may be initiated by a system control processor of the composed information handling system, and may be continued by a system control processor manager. The result of the monitoring may be specified in FIG. 5.2.

Turning to FIG. 5.2, FIG. 5.2 shows a flowchart of a method in accordance with one or more embodiments of the invention. The method depicted in FIG. 5.2 may be performed to re-composed a composed information handling system in accordance with one or more embodiments of the invention. The method shown in FIG. 5.2 may be performed by, for example, a system control processor manager (e.g., 50, FIG. 1.1). Other components of the system in FIG. 1.1 may perform all, or a portion, of the method of FIG. 5.2 without departing from the invention.

While FIG. 5.2 is illustrated as a series of steps, any of the steps may be omitted, performed in a different order, additional steps may be included, and/or any or all of the steps may be performed in a parallel and/or partially overlapping manner without departing from the invention.

In step 520, health of computing resources of a composed information handling system is monitored. The computing resources may be monitored by obtaining health information regarding the hardware devices providing the computing resources. For clarity purposes, the composed information handling system monitored in step 520 may be further referred to as the monitored composed information handling system.

The health of the computing resources may be monitored by intercepting bare metal communications between the hardware devices of a control resource set and the hardware devices of a hardware resource set. The bare metal communications may be analyzed to ascertain whether requests by devices of either set are being serviced by the corresponding devices of the other set. The aforementioned information may be used to infer whether any of the hardware devices of the compute resource set or hardware resource set are compromised.

The health of the computing resources may be monitored by invoking the health reporting functionality of the hardware devices of the compute resource set and/or hardware resource set. For example, a system control processor manager may send appropriate requests to the system control processor(s) of the composed information handling system. The requests may be forwarded to any of these hardware devices. The hardware devices may provide, in response to the requests, health information, diagnostic reports, and/or other types of information that may be used to infer whether any of the hardware devices of the compute resource set or hardware resource set are compromised. Such information may, in turn, be provided to the system control processor manager.

In step 522, it is determined whether the monitoring indicates a compromised state of a device. The monitoring may indicate a compromised state when it indicates that it is likely that the device will be unlikely to provide computing resources to a composed information handling system, entirely or in part, in the future (or currently). For example, when a health reporting function is invoked, a report regarding the operational expectancy of the device may be provided. The report may indicate whether the device is likely to or already is in a compromised state.

If it is determined that the monitoring indicates a compromised state of a device, then the method may proceed to step 524. In one or more embodiments of the invention, the compromised state further corresponds to whether the first information handling system is capable of remediating the device using, e.g., a second resource in a reserved pool of the information handling system. The device may be in a compromised state if the device cannot be remediated using a second resource of the information handling system. If the monitoring does not indicate that a device is in a compromised state, then the method may return to step 520.

In step 524, at least a second composed information handling system with similar resources and a lower priority is identified. In one or more embodiments of the invention, the priority may be stored in a telemetry data map (e.g., 412, FIG. 4) of the system control processor manager. The priority may be a representation of the value of the composed information handling system relative to other composed information handling systems.

The system control processor manager may analyze the telemetry data map to identify a subset of composed information handling systems that both (i) have allocated to them the computing resources similar to the compromised computing resources of the monitored information handling system and (ii) are associated with a priority lower than that of the monitored composed information handling system. Further, the system control processor manager may select, from the subset, a composed information handling system associated with a priority that is lower priority than that of the monitored composed information handling system. The selected composed information handling system may be the second composed information handling system. In one or more embodiments of the invention, if the monitoring indicates that more than one computing resources are in a compromised state, then the process of identifying computing resources of a lower priority may be repeated to replace the compromised computing resources.

In step 526, a deallocation of at least one computing resource of the second information handling system is initiated. In one or more embodiments of the invention, the deallocation includes issuing a decomposition request to each identified composed information handling system. The decomposition request may specify performing a decomposition of the composed information handling systems. Further, the decomposition request may specify placing each computing resource of the decomposing information handling system in a reserved pool reserved for the monitored composed information handling system. The system control processors of each composed information handling system may, in response to the decomposition request, provide responses that each specifies that the corresponding composed information handling system has been decomposed, and the computing resources have been placed in the reserved pool. In this manner, the requested computing resource(s) has been made available to replace the compromised computing resource(s).

In step 528, a reallocation of the deallocated computing resources to the first composed information handling system is initiated. In one or more embodiments of the invention, the reallocation is initiated by sending messages to the system control processor of the monitored composed information handling system that indicate deallocating the compromised computing resource(s) from the monitored composed information handling system. Further, the messages may specify allocating the replacement computing resources from the reserved pool. The replacement computing resources may be at least a portion of the computing resources deallocated in step 526.

In one or more embodiments of the invention, the reallocation may further include, prior to the deallocation of the compromised computing resources and the allocation of the replacement computing resources, pausing the operation of the monitored composed information handling system, performing the reallocation, and restarting the monitored composed information handling system such that the monitored composed information handling system utilizes the replacement computing resources.

Using the method illustrated in FIG. 5.2, a system in accordance with embodiments of the invention may automatically and/or transparently recompose computing resources that have been compromised. The resources may be recomposed as part of a restart (e.g., boot) of the composed information handling system.

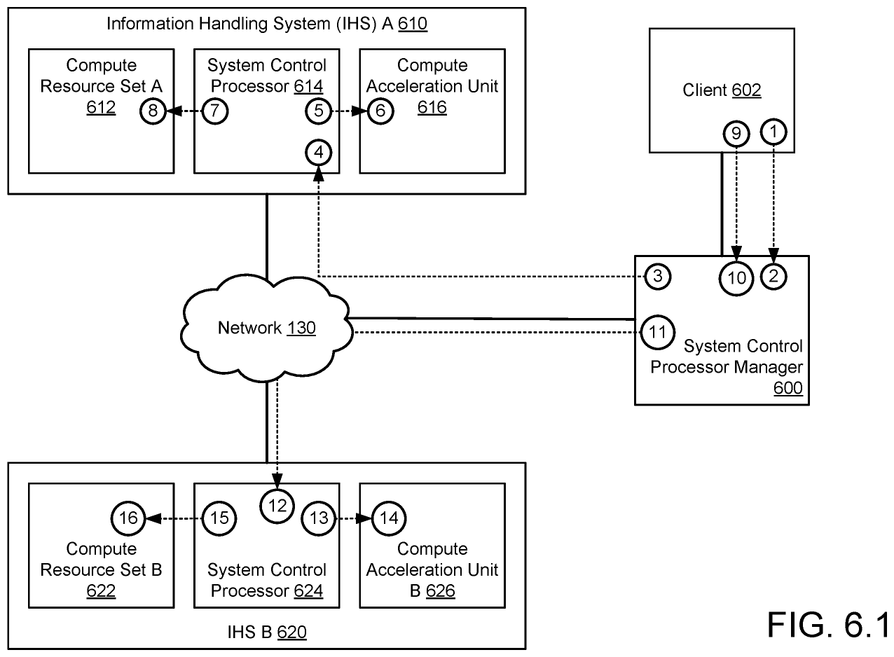

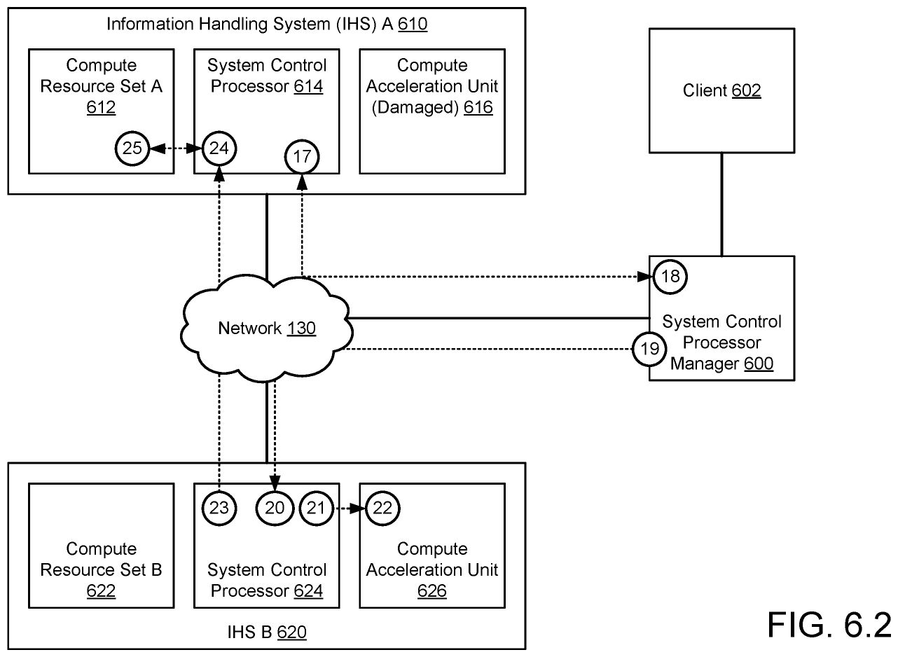

To further clarify embodiments of the invention, a non-limiting example is provided in FIGS. 6.1-6.2. FIGS. 6.1-6.2 each show a system similar to that illustrated in FIG. 1.1. Actions performed by components of the system are illustrated by numbered, circular boxes interconnected, in part, using dashed lines terminating in arrows. For the sake of brevity, only a limited number of components of the system of FIG. 1.1 is illustrated in FIGS. 6.1-6.2.

### EXAMPLE

Consider a scenario as illustrated in FIG. 6.1 in which a system control processor manager (600) has instantiated a composed information handling system for a client. At step 1, the client sends a composition request to the system control processor manager (600) that manages two information handling systems (610, 620). The composition request specifies that database services are to be provided for the client.

In response to the composition request, the system control processor manager (600), at step 2, translates the intent of the client (e.g., to obtain database services) into a listing of computing resources for a composed information handling system to provide the services. The listing includes the system control processor (614), compute resource set A (612), and compute acceleration unit (616) of the information handling system A (610).

Based on the listing, the system control processor manager (600), at step 3, generates and sends a second composition request to the system control processor (614) of the information handling system A (610) indicating compute resource set A (612) is to be presented with the compute acceleration unit (616) to instantiate a composed information handling system to provide the database services.

In response to the instructions, at step 4, the system control processor (614) identifies that the compute acceleration unit (616) is to be presented to the compute resource set A (612). To prepare the compute acceleration unit (616) for allocation, at step 5, the system control processor (614) sets the state of the compute acceleration unit (616) consistent with drivers employed by the system control processor (614) for communications purposes. The system control processor (614) then allocates the compute acceleration unit (616) to the composed information handling system in step 6.

Once the compute acceleration unit (616) is prepared for presentation, the system control processor (614) at step 7, presents the compute acceleration unit (616) as bare metal resources to the compute resource set A (612). Consequently, at step 8, the compute resource set A (612) identifies and begins to use the compute acceleration unit (616) by offloading database related tasks to the compute acceleration unit (616). Accordingly, the composed system begins to provide the requested database services to the client (602). When doing so, the state of the compute acceleration unit (616) changes over time to provide its functionality. Consequently, the operation of the compute acceleration unit (616) becomes dependent upon its state. Further, the system control manager (600) may determine, as specified in the composition request, that the composition request is of a high priority.

In addition to initiating the composition of the first composed information handling system, the client (602), at step 9, further sends an additional composition request. The composition request may specify instantiating a second composed information handling system that provides secondary database services. The composition request may further specify that the secondary database services are of a lower priority than that of the first composed information handling system.

In response to the composition request, the system control processor manager (600), at step 10, translates the intent of the client (e.g., to obtain secondary database services) for the second composed information handling system into a listing of computing resources for a composed information handling system to provide the services. The listing includes a second system control processor (624) of IHS B (620), compute resource set B (622), and a second compute acceleration unit B (626).

Based on the listing, the system control processor manager (600), at step 11, generates and sends a second composition request to the system control processor (624) of the information handling system B (620) indicating compute resource set B (622) is to be presented with the compute acceleration unit (626) to instantiate a second composed information handling system to provide the database services.

In response to the instructions, at step 12, the system control processor (624) identifies that the compute acceleration unit B (626) is to be presented to the compute resource set B (622) similar to step 5. The system control processor (624) then allocates the compute acceleration unit (626) to the composed information handling system in step 14.

Once the compute acceleration unit (626) is prepared for presentation, the system control processor (624) at step 15, presents the compute acceleration unit (626) as bare metal resources to the compute resource set B (622). Consequently, at step 16, the compute resource set B (622) identifies and begins to use the compute acceleration unit (626).

Turning to FIG. 6.2, as time passes, compute resource set A (612) sends numerous bare metal communications to the system control processor (614) to have data stored in the storage unit (616). Due to the high usage of the compute acceleration unit (616), the compute acceleration unit (616) begins to lose computing power quality.

As the compute acceleration unit (616) begins to fail, the system control processor (614), in step 17, monitors the health of the compute acceleration unit (616) and provides a health report to the system control processor manager (600). The system control processor manager (600), using the health report, determines that the storage resources provided by the compute acceleration unit (616) have become compromised due to the likely future failure of the compute acceleration unit (616).

In response, at step 19, the system control processor manager (600) identifies the second composed information handling system as being in a lower priority of that of the first composed information handling system. In addition, the system control processor manager (600) determines that the compute acceleration unit (626) of IHS B (620) may be used to replace the damaged compute acceleration unit (616). Further to the identification, the system control processor manager (600) initiates a deallocation of the second composed information handling system by sending a decomposition request to the system control processor (624) of IHS B (620). In step 20, the system control processor (624) of IHS B (620) obtains the decomposition request.

In response, at step 21, the system control processor (624) prepares and presents the compute acceleration unit (626) to the first composed information handling system. At step 22, the second compute acceleration unit (626) is deallocated from the second composed information handling system and prepared to replace the damaged compute acceleration unit (616).

In response, the system control processor (624), at step 23, sets up management services for the compute acceleration unit (626). At step 24, the system control processor (614) allocates the compute acceleration unit (626) for allocation to the composed information handling system. Further, the system control processor (614) establishes a connection with the compute acceleration unit (626) via the system control processor (624) of IHS B (620).

In response, the system control processor (614) transfers operation of the compute acceleration unit (616) to the second compute acceleration unit (626) by way of system control processor (624), and the compute acceleration unit (626) is presented to the compute resource set A (612) as bare metal resources. Consequently, at step 25, the compute resource set A (612) discovers the available resource and begins to use it without being aware that the resources are being provided by a different compute acceleration unit (prior to recomposition).

The system control processor (614) may also deallocate the compute acceleration unit (616) thereby releasing it.

### END OF EXAMPLE

Thus, as illustrated in FIGS. 6.1-6.2, embodiments of the invention may provide for the recomposition of computing resources.

As discussed above, embodiments of the invention may be implemented using computing devices. FIG. 7 shows a diagram of a computing device in accordance with one or more embodiments of the invention. The computing device (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), input devices (710), output devices (708), and numerous other elements (not shown) and functionalities. Each of these components is described below.

In one embodiment of the invention, the computer processor(s) (702) may be an integrated circuit for processing instructions. For example, the computer processor(s) may be one or more cores or micro-cores of a processor. The computing device (700) may also include one or more input devices (710), such as a touchscreen, keyboard, mouse, microphone, touchpad, electronic pen, or any other type of input device. Further, the communication interface (712) may include an integrated circuit for connecting the computing device (700) to a network (not shown) (e.g., a local area network (LAN), a wide area network (WAN) such as the Internet, mobile network, or any other type of network) and/or to another device, such as another computing device.

In one embodiment of the invention, the computing device (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing devices exist, and the aforementioned input and output device(s) may take other forms.

Embodiments of the invention may provide a system and method for dynamically instantiating and recomposing composed information handling systems. Specifically, embodiments of the invention may provide for health monitoring of computing resources of a composed information handling systems. If the monitoring indicates that the computing resources have been compromised, the computing resources may be automatically recomposed by reallocating resources from composed information handling system of lower priority. Consequently, computer implemented services may not be negatively impacted by the compromised state of the computing resources. Further, computing resources may be replaced even when all computing resources have been allocated.

Thus, embodiments of the invention may address the problem of limited computing resources in a distributed system. For example, by recomposing computing resources, composed information handling system may not need to be over-provisioned with computing resources to address potential compromises of the computing resources. Accordingly, it may be more likely that desired computer implemented services are provided at reduced levels of allocated computing resources. Thus, embodiments of the invention may more efficiently marshal limited computing resources to provide desired services.

The problems discussed above should be understood as being examples of problems solved by embodiments of the invention of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as of the invention. Accordingly, the scope of the invention should be limited only by the attached claims.

What is claimed is:

1. A system for managing composed information handling systems, comprising:
persistent storage; and
a system control processor manager programmed to:
after being allocated to a composed information handling system of the composed information handling systems:
monitor health of computing resources of the composed information handling system;
make a determination, based on the monitoring of the health of the computing resources, that a computing resource of the computing resources is in a compromised state;
based on the determination, identify a second computing resource currently allocated to a second composed information handling system, wherein the composed information handling system is associated with a first priority and the second composed information handling system is associated with a second priority, wherein the first priority is higher than the second priority, wherein the identifying is based at least on the first priority and the second priority;
deallocate, based on the identifying, the second computing resource currently allocated to the second composed information handling system; and
replace, after the deallocating, the compute resource with the second compute resource in the composed information handling system.

2. The system of claim 1, wherein deallocating the second computing resource comprises:
issuing a decomposition request to the second composed information handling system; and
determining, after issuing the decomposition request, that the second composed information handling system has been decomposed,
wherein the second computing resource is available to replace the computing resource after the second composed information handling system is decomposed.

3. The system of claim 1, wherein replacing the compute resource with the second compute resource in composed information handling system comprises:
deallocating the computing resource from the composed information handling system; and
allocating the second computing resource to the composed information handling system.

4. The system of claim 1, wherein identifying the second computing resource comprises:
identifying a plurality of replacement computing resources to replace the computing resource, wherein each of the plurality of replacement computing resources is associated with a priority;
identifying a subset of the plurality of replacement computing resources that are associated with a priority that is lower than the first priority; and
selecting the second computing resource from the subset of the plurality of replacement computing resources.

5. The system of claim 1, wherein the system control processor manager is further programmed to:
make a second determination, based on the monitoring of the health of the computing resources, that a third computing resource of the computing resources is in the compromised state;
based on the second determination, identify a fourth computing resource currently allocated to a third composed information handling system, wherein the third composed information handling system is associated with a third priority, wherein the first priority is higher than the third priority, wherein the identifying of the fourth computing resource is based at least on the first priority and the third priority; and
replace the third compute resource with the fourth compute resource in the composed information handling system.

6. The system of claim 1, wherein the composed information handling system comprises a compute resource set, a hardware resource set, and a control resource set comprising the system control processor.

7. The system of claim 6, wherein the control resource set presents abstracted computing resources of the hardware resource set as bare metal resources to the compute resource set.

8. The system of claim 7, wherein system control processor monitors the health of the computing resources based on intercepted bare metal communications between the compute resource set and the hardware resource set to obtain monitoring information and provides the monitoring information to the system control processor manager.

9. The information handling system of claim 7, wherein system control processor monitors the health of the computing resources based on health reporting functionality of hardware devices of the hardware resource set to obtain monitoring information and provides the monitoring information to the system control processor manager.

10. A method for providing computer implemented services using information handling systems, comprising:
after being allocated to a composed information handling system of the composed information handling systems:
monitoring, by a system control processor manager, health of computing resources of the composed information handling system;
making a determination, based on the monitoring of the health of the computing resources, that a computing resource of the computing resources is in a compromised state;
based on the determination, identifying a second computing resource currently allocated to a second composed information handling system, wherein the composed information handling system is associated with a first priority and the second composed information handling system is associated with a second priority, wherein the first priority is higher than the second priority, wherein the identifying is based at least on the first priority and the second priority;
deallocating, based on the identifying, the second computing resource currently allocated to the second composed information handling system; and
replacing, after the deallocating, the compute resource with the second compute resource in the composed information handling system.

11. The method of claim 10, wherein deallocating the second computing resource comprises:
issuing a decomposition request to the second composed information handling system; and
determining, after issuing the decomposition request, that the second composed information handling system has been decomposed,
wherein the second computing resource is available to replace the computing resource after the second composed information handling system is decomposed.

12. The method of claim 10, wherein replacing the compute resource with the second compute resource in composed information handling system comprises:
deallocating the computing resource from the composed information handling system; and
allocating the second computing resource to the composed information handling system.

13. The method of claim 15, wherein identifying the second computing resource comprises:
identifying a plurality of replacement computing resources to replace the computing resource, wherein each of the plurality of replacement computing resources is associated with a priority;
identifying a subset of the plurality of replacement computing resources that are associated with a priority that is less than the first priority; and
selecting the second computing resource from the subset of the plurality of replacement computing resources.

14. The method of claim 10, further comprising:
making a second determination, based on the monitoring of the health of the computing resources, that a third computing resource of the computing resources is in the compromised state;
based on the second determination, identifying a fourth computing resource currently allocated to a third composed information handling system, wherein the third composed information handling system is associated with a third priority, wherein the first priority is higher than the third priority, wherein the identifying of the fourth computing resource is based at least on the first priority and the third priority; and
replacing the third compute resource with the fourth compute resource in the composed information handling system.

15. The method of claim 10, wherein the composed information handling system comprises a compute resource set, a hardware resource set, and a control resource set comprising the system control processor.

16. The method of claim 15, wherein the control resource set presents abstracted computing resources of the hardware resource set as bare metal resources to the compute resource set.

17. The method of claim 16, wherein system control processor monitors the health of the computing resources based on intercepted bare metal communications between the compute resource set and the hardware resource set to obtain monitoring information and provides the monitoring information to the system control processor manager.

18. The method of claim 16, wherein system control processor monitors the health of the computing resources based on health reporting functionality of hardware devices of the hardware resource set to obtain monitoring information and provides the monitoring information to the system control processor manager.

19. A non-transitory computer readable medium comprising computer readable program code, which when executed by a computer processor enables the computer processor to perform a method for providing computer implemented services using information handling systems, the method comprising:
after being allocated to a composed information handling system of the composed information handling systems:
monitoring health of computing resources of the composed information handling system;
making a determination, based on the monitoring of the health of the computing resources, that a computing resource of the computing resources is in a compromised state;
based on the determination, identifying a second computing resource currently allocated to a second composed information handling system, wherein the composed information handling system is associated with a first priority and the second composed information handling system is associated with a second priority, wherein the first priority is higher than the second priority, wherein the identifying is based at least on the first priority and the second priority;
deallocating, based on the identifying, the second computing resource currently allocated to the second composed information handling system; and
replacing, after the deallocating, the compute resource with the second compute resource in the composed information handling system.

20. The non-transitory computer readable medium of claim 17, wherein deallocating the second computing resource comprises:
issuing a decomposition request to the second composed information handling system; and
determining, after issuing the decomposition request, that the second composed information handling system has been decomposed,
wherein the second computing resource is available to replace the computing resource after the second composed information handling system is decomposed.
